(19) United States
(12) Patent Application Publication
(10) Pub. No.: US 2023/0196067 A1
(43) Pub. Date: Jun. 22, 2023

(54) OPTIMAL KNOWLEDGE DISTILLATION SCHEME

(71) Applicant: Lemon Inc., Grand Cayman (KY)

(72) Inventors: Peng Wang, Los Angeles, CA (US); Dawei Sun, Los Angeles, CA (US); Xiaochen Lian, Los Angeles, CA (US)

(21) Appl. No.: 17/554,656

(22) Filed: Dec. 17, 2021

(51) Int. Cl. G06N 3/04; G06V 10/776

(52) U.S. Cl. CPC G06N 3/0427; G06N 3/0454; G06V 10/776

(57) ABSTRACT

The present disclosure describes techniques of identifying optimal scheme of knowledge distillation (KD) for vision tasks. The techniques comprise configuring a search space by establishing a plurality of pathways between a teacher network and a student network and assigning an importance factor to each of the plurality of pathways; searching the optimal KD scheme by updating the importance factor and parameters of the student network during a process of training the student network; and performing KD from the teacher network to the student network by retraining the student network based at least in part on the optimized importance factors.

### BACKGROUND

Neural networks attempt to simulate the operations of the human brain. They can be incredibly complicated and usually consist of millions of parameters to classify and recognize input they receive. Nowadays, neural networks are widely used in vision tasks, video creation, music generation, and other fields. Techniques of neural network generation are crucial to implementation of neural networks. However, conventional neural network generation techniques may not fulfil needs of users due to various limitations. Therefore, improvements in neural network generation techniques are needed.

### BRIEF DESCRIPTION OF THE DRAWINGS

The following detailed description may be better understood when read in conjunction with the appended drawings. For the purposes of illustration, there are shown in the drawings example embodiments of various aspects of the disclosure; however, the invention is not limited to the specific methods and instrumentalities disclosed.

FIG. 1 illustrates an example system including a cloud service that may be used in accordance with the present disclosure.

FIG. 2 illustrates an example framework of the search space configured in accordance with the present disclosure.

FIG. 3 illustrates an example framework comprising two phases for searching optimal Knowledge Distillation (KD) scheme and performing KD in accordance with the present disclosure.

FIG. 4 illustrates an example pseudocode for searching optimal KD scheme and performing KD in accordance with the present disclosure.

FIG. 5 illustrates an example process for searching optimal KD scheme and performing KD in accordance with the present disclosure.

FIG. 6 illustrates an example process for searching optimal KD scheme and performing KD in accordance with the present disclosure.

FIG. 7 illustrates an example transform block which may be used in accordance with the present disclosure.

FIG. 8 illustrates an example self-attention block which may be used in accordance with the present disclosure.

FIG. 9 illustrates example sizes of the search space on different datasets in accordance with the present disclosure.

FIG. 10 illustrates performance comparison of different schemes.

FIG. 11 illustrates performance comparison of different schemes.

FIG. 12 illustrates performance comparison of different schemes.

FIG. 13 illustrates example training curves on CIFAR-100 dataset.

FIG. 14 illustrates performance comparison of different normalization methods.

FIG. 15 illustrates an example computing device that may be used in accordance with the present disclosure.

### DETAILED DESCRIPTION OF ILLUSTRATIVE EMBODIMENTS

Knowledge Distillation (KD) plays an important role in improving neural networks. KD is a model compression method in which a small model is trained to mimic a pre-trained larger model. KD can transfer knowledge from a good performing larger Deep Neural Network (DNN) to a given smaller network. For example, KD can transfer knowledge from a teacher model to a student model. In the past few years, KD has achieved remarkable improvements in training efficient models for image classification, image segmentation, object detection, and so on. Recently, KD is widely implemented in various model deployment over mobiles or other low-power computing devices. Improvements to knowledge distillation can bring strong benefits in numerous applications.

Improvements to automatically find an optimal teaching scheme of KD between a fixed teacher and a given student are desirable. The present disclosure provides techniques for automatically finding a teaching scheme for KD and efficiently learning an optimal KD scheme. For a given pair of teacher and student networks, a set of transmitting feature maps from the teacher network and receiving feature maps from the student network may be sampled and defined. Meanwhile, a set of transform blocks may be added for converting a transmitting feature map to match with a receiving feature map for loss computation. For each pathway, an importance factor a may be assigned, and a differentiable meta-learning pipeline may be used to find its optimal value. In some embodiments, a KD may be performed with the learnt a value.

For a given pathway of distillation, the frame LATTE (LeArning To Teach for KD) in accordance with the present disclosure may generate a weighting process. The weighting process may contain more information beyond the final learnt value. The weighting process is a learnt process for the importance factor a. The weighting process learnt by LATTE may produce better results than adopting a fixed distillation weight to balance different losses. In some embodiments, the learnt process may be adopted to reweight each pathway for KD training and generating a distilled student model for deployment. The techniques described in the present disclosure have been validated based on various vision tasks, such as image classification, image segmentation, and depth estimation. The framework in accordance with the present disclosure performs better than existing KD techniques.

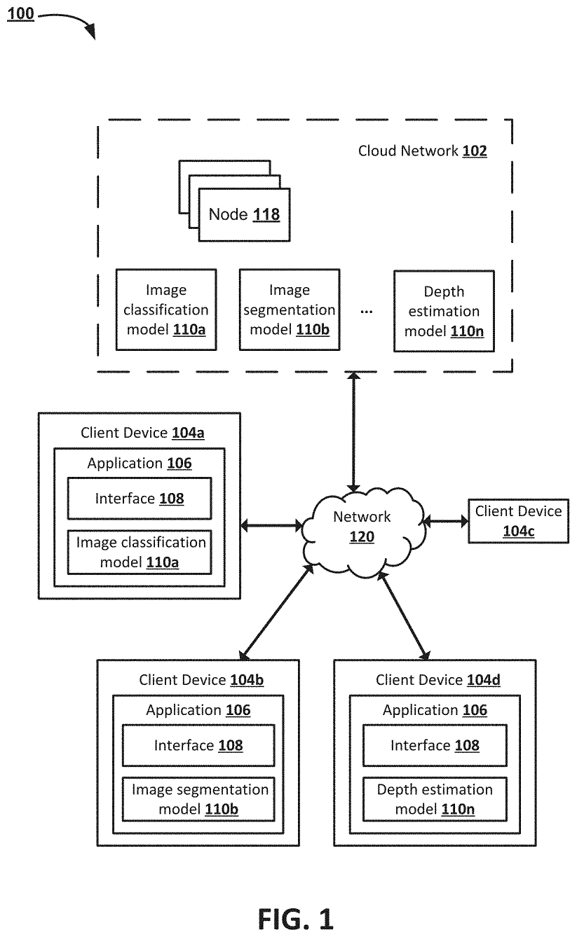

The neural networks for improving knowledge distillation may be integrated into and/or utilized by a variety of systems. FIG. 1 illustrates an example system 100 that may be used in accordance with the present disclosure. The system 100 may comprise a cloud network 102 or a server device and a plurality of client devices 104a-d. The cloud network 102 and the plurality of client devices 104a-d may communicate with each other via one or more networks 120. The cloud network 102 may be located at a data center, such as a single premise, or be distributed throughout different geographic locations (e.g., at several premises). The cloud network 102 may provide the services via the one or more networks 120. The network 120 comprise a variety of network devices, such as routers, switches, multiplexers, hubs, modems, bridges, repeaters, firewalls, proxy devices, and/or the like. The network 120 may comprise physical links, such as coaxial cable links, twisted pair cable links, fiber optic links, a combination thereof, and/or the like. The network 120 may comprise wireless links, such as cellular links, satellite links, Wi-Fi links and/or the like. In an embodiment, a user may use an application 106 on a client device 104, such as to interact with the cloud network 102. The client devices 104 may access an interface 108 of the application 106.

A plurality of computing nodes 118 may perform various tasks, e.g., vision tasks. The plurality of computing nodes 118 may be implemented as one or more computing devices, one or more processors, one or more virtual computing instances, a combination thereof, and/or the like. The plurality of computing nodes 118 may be implemented by one or more computing devices. The one or more computing devices may comprise virtualized computing instances. The virtualized computing instances may comprise a virtual machine, such as an emulation of a computer system, operating system, server, and/or the like. A virtual machine may be loaded by a computing device based on a virtual image and/or other data defining specific software (e.g., operating systems, specialized applications, servers) for emulation. Different virtual machines may be loaded and/or terminated on the one or more computing devices as the demand for different types of processing services changes. A hypervisor may be implemented to manage the use of different virtual machines on the same computing device.

In an embodiment, the cloud network or server 102 and/or the client devices 104 may comprise one or more neural networks. The techniques described in the present disclosure may have been utilized to improve neural networks. For example, the techniques in accordance with the present disclosure may have been utilized to improve vision task models, such as an image classification model 110a, an image segmentation model 110b, a depth estimation model 110n. Other neural networks not depicted in FIG. 1 may additionally, or alternatively, be included in the cloud network 102 or any of the client devices 104.

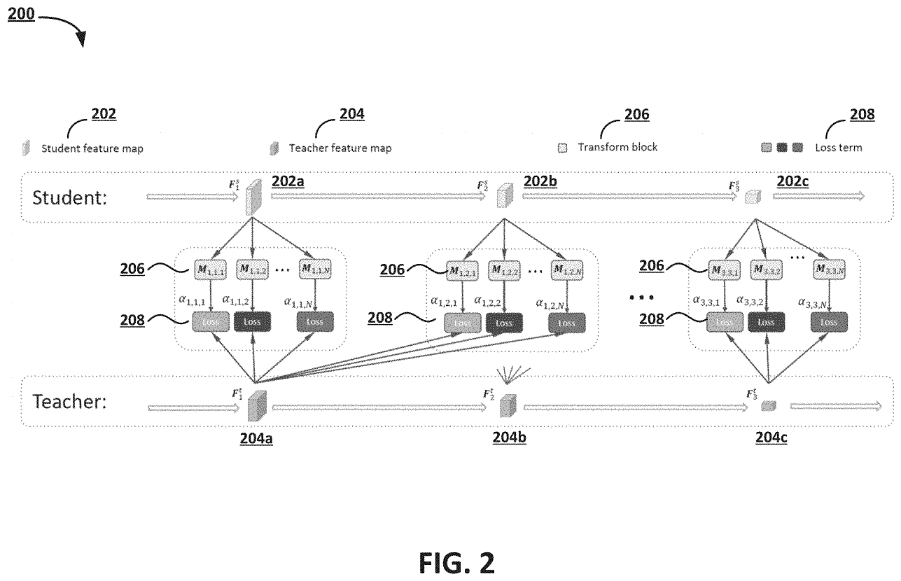

FIG. 2 illustrates an example search space 200 in accordance with the present disclosure. The search space 200 may be used to automatically search an optimal KD scheme for vision tasks. The search space comprises student feature maps 202, teacher feature maps 204, and transform blocks 206. The student feature maps 202 (i.e., 202a, 202b, . . . , 202n) may be selected from a student network. Each of the student feature maps 202 may be denoted as Fⱼ^{s} (e.g., F₁^{s}, F₂^{s}, F₃^{s}). The teacher feature maps 204 (i.e., 204a, 204b, . . . , 204n) may be selected from a teacher network. Each of the teacher feature maps 204 may be denoted as Fᵢ^{t}(e.g., F₁^{t}, F₂^{t}, F₃^{t}).

Feature maps Fᵢ^{t} and Fⱼ^{s} may come from any stage of the teacher network and the student network. Consequently, the feature maps may be in different shapes. The feature maps in different shapes may not be compared directly. Thus, additional computation may be required to transform these feature maps into a same shape for comparison. To this end, a plurality of transform blocks 206 may be added after each of the student feature maps Fⱼ^{s}. The plurality of transform blocks 206 may be denoted as M_{i,j,1}, M_{i,j,2}, . . . , M_{i,J,N}. The transform blocks 206 may be any differentiable computation. For instance, the transform blocks 206 may comprise several convolution layers and an interpolation layer to transform the spatial resolution of the feature maps.

For each pair of teacher/student feature maps, a plurality of loss terms 208 may be computed to measure the difference between the teacher feature map and the student feature map. An importance factor α_{i,j,k} (e.g, α_{1,1,1}, a_{1,1,2}, . . . α_{1,1,N} etc.) may be assigned to each loss term. The importance factor α_{i,j,k} may be used to evaluate the importance of each pathway for knowledge distillation.

For a given pair of teacher and student networks, a set of transmitting feature maps from the teacher (e.g., teacher feature maps 204) may be sampled and defined. A set of receiving feature maps from the student (e.g., student feature maps 202) may also be sampled and defined. A set of transforms (e.g., transform blocks 206) may be proposed as well. The set of transform blocks 206 may be pre-defined. The set of transform blocks 206 may convert a receiving feature map to match with a transmitting feature map for loss computation.

A set of distillation pathways from transmitting layers in the teacher network to receiving layers in the student network may be generated. For each pathway, an importance factor may be assigned. A differentiable meta-learning pipeline may be used to find its optimal value. Optimized importance factors may be found and stored. Using the learnt importance factors, each pathway may be reweighted for KD training and generating a distilled student model for deployment.

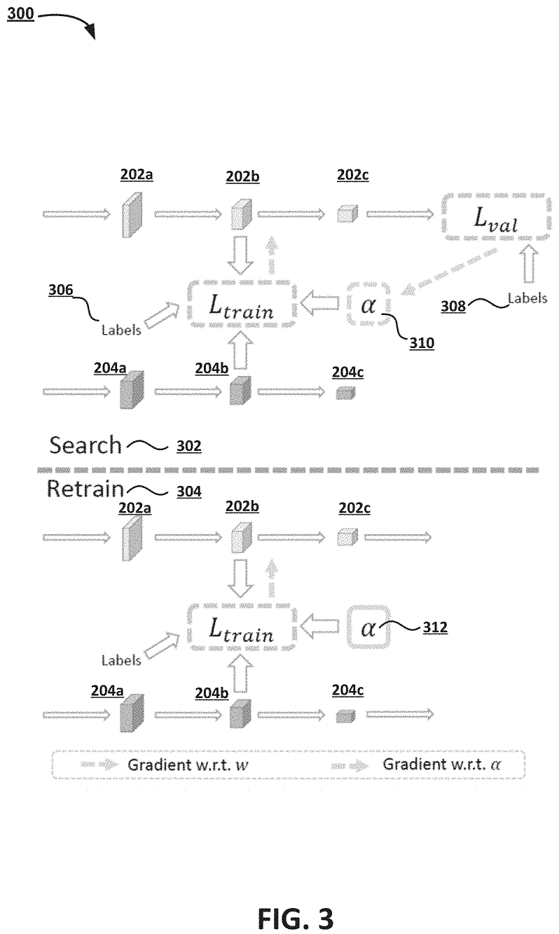

FIG. 3 illustrates an example framework 300 for finding an optimal KD scheme and performing KD based on the optimal KD scheme. The example framework 300 may be implemented using a search space, such as the search space 200 as shown in FIG. 2. A plurality of pathways may be established between a teacher network and a student network, e.g., a pathway from the teacher feature map 204b to the student feature map 202b. An importance factor a may be assigned to each of the plurality of pathways, e.g., the pathway from the teacher feature map 204b to the student feature map 202b.

The example framework 300 may comprise a searching phase 302 and a retraining phase 304. The optimal KD scheme may be found during the searching phase 302. The optimal KD scheme may be found by optimizing the importance factor. The searching phase 302 may be a process of training a student network. A dataset may be split into a training dataset and a validation dataset for the process of training the student network. The student network may be trained on the training dataset with a training loss Lₜᵣₐᵢₙ encoding the supervision from both ground truth labels 306 associated with the training dataset and the teacher network (e.g., the teacher feature maps 204b). The validation dataset may be used to evaluate the performance of the student network. In the validation process, a validation loss Lᵥₐₗ may only measure a difference between the output of the student network and ground truth labels 308 associated with the validation dataset. In an example, the importance factor 310 and parameters of the student network may be updated alternately in the searching phase. An optimized importance factor minimizing the validation loss may be found in the searching phase.

In the retraining phase 304, the student network may be retrained using the optimized importance factor obtained from the searching phase 302 and all available data. For example, all available data may comprise the training dataset and the validation dataset used during the process of training the student network. Each pathway may be reweighted based on a learned process for the importance factor. In the retraining phase, only the parameters of the student network are updated. Knowledge distillation may be performed by retraining the student network with the optimized importance factor and all available data. For example, knowledge may be transferred from the teacher feature map 204b to the student feature map 202b by retraining the student network using the entire set of data (including both the training dataset and validation dataset used in the searching phase) and the optimized importance factor 312.

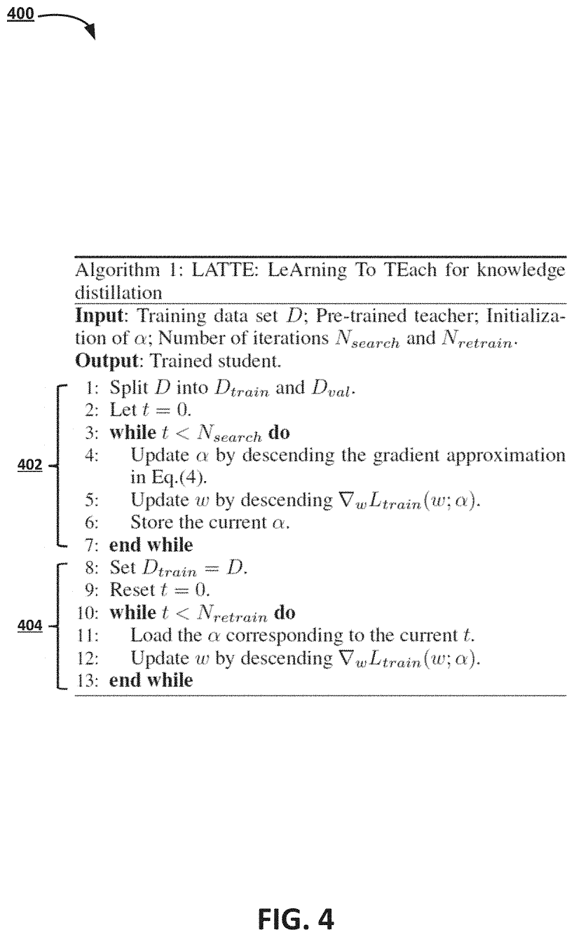

FIG. 4 illustrates an example algorithm 400 for searching an optimal KD scheme and using the optimal scheme to transfer knowledge from a pretrained teacher network to a student network. The example algorithm 400 may be used to implement the example framework 300 as shown in FIG. 3.

In a teacher network, intermediate feature maps may contain plentiful knowledge. The knowledge may be transferred from the teacher network to a student network. For an input image, the output of the student network may be shown as follows.

S(X):=S_{L}_{ₛ}∘ . . . ∘S₂∘S₁(X), Equation 1

wherein S denotes the student network, X denotes the input image, Sᵢ represents the i-th layer of the student network, and Lₛ represents the number of layers in the student network.

In a student network, the k-th intermediate feature map of the student network may be defined as follows.

Fₖ^{s}(X):=Sₖ∘ . . . ∘S₂∘S₁(X), 1≤k≤Lₛ, Equation 2

wherein Fₖ^{s} denotes the k-th intermediate feature map of the student network, X denotes the input image, Sₖ represents the k-th layer of the student network, and Lₛ represents the number of layers in the student network.

The intermediate feature map of the teacher neural network may be denoted by Fₖ^{t}, 1≤k≤Lₜ, wherein Lₜ represents the number of layers in the teacher neural network. The i-th feature map of the teacher neural network may be denoted by Fᵢ^{t}. The the j-th feature map of the student neural network may be denoted by Fⱼ^{s}. As mentioned above, knowledge may be transferred from the i-th feature map of the teacher neural network (i.e., Fᵢ^{t}) to the j-th feature map of the student neural network (i.e., Fⱼ^{s}).

Feature maps Fᵢ^{t} and Fⱼ^{s} may come from any stage of the teacher neural network and the student neural network. Consequently, the feature maps may be in different shapes. The feature maps in different shapes may not be compared directly. Therefore, additional computation may be required to transform the feature maps, which are in different shapes, into a same shape for comparison. To implement the transformation, transform blocks (e.g., transform blocks 206 as shown in FIG. 2) may be added after feature map of the student neural network (i.e., Fⱼ^{s}). The transform blocks may be any differentiable computation. For instance, the transform blocks may comprise a plurality of convolution layers, a plurality of batch normalization layers, and an interpolation layer to transform the spatial resolution of the feature maps.

The loss term may be used to measure the difference between the feature maps of teacher neural network (i.e., Fᵢ^{t}) and the feature maps of the student neural network (i.e., Fⱼ^{s}). The loss may be computed by the following equation.

ι(Fⱼ^{s}, Fᵢ^{t}:=δ(M(Fⱼ^{s}), Fᵢ^{t}), Equation 3

wherein ι denotes the loss term, M denotes the transform blocks, δ represents the distance function and may be L1 distance, L2 distance, etc.

Input from the example algorithm 400 may comprise a dataset D, a pre-trained teacher model, initialized importance factors α. N_{search} denotes a number of iterations in the searching phase 402. Nᵣₑₜᵣₐᵢₙ denotes a number of iterations in the retraining phase 404. The searching phase 402 may be utilized to search optimal importance factors α. In the searching phase 402, the dataset D may be split into a training dataset Dₜᵣₐᵢₙ and a validation dataset Dᵥₐₗ for training the student network. For example, 80% of the dataset D may be used for training (i.e., Dₜᵣₐᵢₙ) and 20% of the dataset D may be used for validating (i.e., Dᵥₐₗ). The student model may be trained on the training dataset Dₜᵣₐᵢₙ with a loss encoding the supervision from both the ground truth label and the teacher neural network. The validation dataset Dᵥₐₗ may be used to evaluate the performance of the trained student on unseen inputs. During validation, the validation loss may only measure the difference between the output of the student and the ground truth label.

The training dataset may be represented by Dₜᵣₐᵢₙ:={(Xᵢ, yᵢ)}ᵢ₌₁^{|D}^{ᵥₐₗ}^{|}, wherein yᵢ is the label of image Xᵢ. The validation dataset may be represented by Dᵥₐₗ:={(Xᵢ, yᵢ)}ᵢ₌₁^{|D}^{ᵥₐₗ}^{|}. For each pair of teacher/student feature maps (i.e., a pair of Fᵢ^{t} and Fⱼ^{s}) in the search space, there may be Nₜ candidate pre-defined transform blocks. The transform blocks may be represented by M_{i,j,1}, M_{i,j,2}, . . . , M_{i,j,Nt}.

The student model may be trained on the training dataset Dₜᵣₐᵢₙ with a loss encoding the supervision from both the ground truth label and the teacher neural network. The loss on the training dataset, Lₜᵣₐᵢₙ(w, α), may be defined as follows.

$${L}_{train} ( w , α ) := \frac{1}{\vert {D}_{train} \vert} {\sum }_{( X , y ) ∈ {D}_{t r a i n}} ( {δ}_{label} ( S ( X ) , y ) + {\sum }_{i = 1}^{{L}_{t}} {\sum }_{j = 1}^{{L}_{s}} {\sum }_{k = 1}^{{N}_{t}} {α}_{i , j , k} δ ( {M}_{i , j , k} ( {F}_{j}^{s} ( X ) ) , {F}_{i}^{t} ( X ) ) ) , \qquad Equation 4$$

wherein w denotes the parameters of the student neural network, α denotes the importance factors and α ∈ [symbol] _{≥0}^{L}^{ₜ}^{×L}^{ₛ}^{×N}^{ₜ}, Dₜᵣₐᵢₙ resents the training dataset δ_{label} represents a distance function which measures difference between labels.

The validation dataset may be used to evaluate the performance of the trained student on unseen inputs. In the process of validation, the validation loss may only measure the difference between the output of the student and the ground truth. The loss on the validation set, Lᵥₐₗ(w), may be defined as follows.

$${L}_{v a l} ( w ) := \frac{1}{\vert {D}_{v a l} \vert} {\sum }_{( X , y ) ∈ {D}_{val}} {δ}_{label} ( S ( X ) , y ) , \qquad Equation 5$$

wherein w denotes the parameters of the student neural network, Dᵥₐₗ denotes the validation dataset, X represents the input image, y represents the label of image X, δ_{label} represents a distance function which measures difference between labels, S(X) represents the output of the student neural network.

The optimization problem may be formulated as follows.

$$\begin{matrix}{min}_{α} & {L}_{val} ( w * ( α ) ) \\ s . t . & w * ( α ) = arg {min}_{w} {L}_{train} ( w , α ) ,\end{matrix} \qquad Equation 6$$

wherein w*(α) denotes the parameters of the student network trained with the importance factor α, Lᵥₐₗ(w*(α)) denotes the loss of w*(α) on the validation dataset, Lₜᵣₐᵢₙ(w, α) denotes the loss on the training dataset.

The optimal KD scheme may be found by optimizing the importance factor α. An optimal importance factor minimizing the validation loss Lᵥₐₗ(w*(α)) may be found in the searching phase. However, this is a nested optimization problem and is difficult to solve. To address the issue, gradient-based method may be utilized. Instead of computing gradient at the exact optimum w*(α) of the inner optimization, the gradient with respect to α, i.e., ∇_{α}Lᵥₐₗ(w*(α)), may be computed at the result of the single-step gradient descent as follows.

∇_{α}Lᵥₐₗ(w*(α))≈∇_{α}Lᵥₐₗ(w−ξ∇_{w}Lₜᵣₐᵢₙ(w, α)), Equation 7

wherein α represents the importance factor, w represents the current parameters of the student neural network, ξ represents the learning rate of the inner optimization, Lᵥₐₗ represents the loss on validation dataset, and Lₜᵣₐᵢₙ represents the loss on training dataset.

The parameters of the student neural network trained with importance factor w*(α) may be approximated with a single step of gradient descent from the current parameter w. More sophisticated gradient-based method may be used to solve the inner optimization, e.g., gradient descent with momentum. When using other gradient-based method, Equation 7 may be modified accordingly. The chain rule may be applied to Equation 7. The result of applying the chain rule may be shown as follows.

∇_{α}Lᵥₐₗ(w−ξ∇_{w}Lₜᵣₐᵢₙ(w, α))=−ξ∇_{α,w}²Lₜᵣₐᵢₙ(w, α)∇hd wLᵥₐₗ(w′), Equation 8

wherein w′=w−ξ∇_{w}−Lₜᵣₐᵢₙ(w, α). In Equation 8, there are second-order derivatives which may result in expensive computation. Therefore, the second-order derivatives may be approximated with finite difference. Consequently, the follow equation may be obtained.

$${∇}_{α , w}^{2} {L}_{train} ( w , α ) {∇}_{w} {L}_{val} ( {w}^{′} ) = \frac{{∇}_{α} {L}_{train} ( {w}^{+} , α ) - {∇}_{α} {L}_{train} ( {w}^{-} , α )}{2 ϵ} , \qquad Equation 9$$

wherein w⁺ denotes w+∈∇_{w}Lᵥₐₗ(w′), w⁻ denotes w−∈∇_{w}Lᵥₐₗ(w′), and ∈ denotes a small positive scalar.

The following approximation may be obtained:

$${∇}_{α} {L}_{v a l} ( {w}^{*} ( α ) ) \approx - ξ \frac{{∇}_{α} {L}_{train} ( {w}^{+} , α ) - {∇}_{α} {L}_{train} ( {w}^{-} , α )}{2 ϵ} , \qquad Equation 10$$

wherein Lᵥₐₗ denotes the loss on validation dataset, Lₜᵣₐᵢₙ denotes the loss on training dataset, w*(α) denotes the parameters of the student neural network trained with importance factor α, and ξ denotes the learning rate of the inner optimization.

To evaluate the expression in Equation 10, the following items may be computed. First, computing w′ may require a forward pass and a backward pass of the student and a forward pass of the teacher. Afterwards, computing w^{±} may require a forward pass and a backward pass of the student. Finally, computing ∇_{α}Lₜᵣₐᵢₙ(w^{±}, α) may require two forward passes of the student. The gradient of Lₜᵣₐᵢₙ with respect to an element of α is just the feature map loss corresponding to this element, so no further backward pass of the student is needed. In conclusion, evaluating the approximated gradient in Equation 10 entails one forward pass of the teacher, and four forward passes and two backward passes of the student.

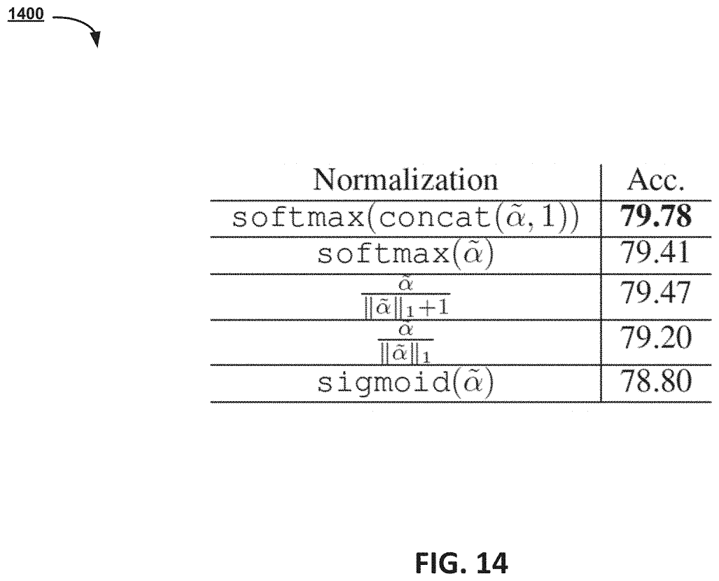

The importance of each knowledge transfer may be adjusted by regulating α. The importance factor α may be optimized to find the optimal KD scheme. In fact, the real decision variable of the optimization is \tilde{α} instead of α. For the purpose of numerical stability, normalization may be applied to \tilde{α}. The importance factor α may be obtained by normalizing \tilde{α}. A plurality of normalization methods may be evaluated. FIG. 14 shows the evaluation results of different normalization methods.

The importance factors a and the parameters of the student neural network w may be updated alternately in the searching phase 402. Due to the efficiency for KD scheme learning of the gradient-based method, importance factors may be updated by descending a gradient approximation based on Equation 10. The evolution of the importance factor in the searching phase 402 may encode much richer information than the final importance factor.

In the retraining phase 404, the optimal importance factors found in the searching phase 402 may be used for KD training and generating a distilled student model for deployment. Only the parameters of the student neural network w may be updated during the retraining phase 404. The retraining phase 404 may be configured to retrain the student neural network with the optimal importance factor and all available data. All available data D may comprise the training dataset Dₜᵣₐᵢₙ and the validation dataset Dᵥₐₗ used during the process of training the student network.

There may be different ways to use the optimal importance factors. In some embodiments, the importance factor obtained at the last iteration in the searching phase may be used for each iteration of the retraining phase. The student network may be retrained using the same importance factor obtained at the last iteration for each iteration of the retraining process. The evolution of the importance factor in the searching phase may encode much richer information than the final importance factor. To make use of that information, in other embodiments, each iteration of the retraining process may use different importance factors. To this end, a new value from the stored importance factors may be loaded (shown in Line 11 in FIG. 4). Since N_{search} is different from Nᵣₑₜᵣₐᵢₙ, linear interpolation may be used to compute the importance factor α for each iteration in the retraining phase. Specifically, the importance factor α for iteration t may be the i-th stored α, where

$$i = ⌊ \frac{{tN}_{s e arch}}{{N}_{retrain}} ⌋ .$$

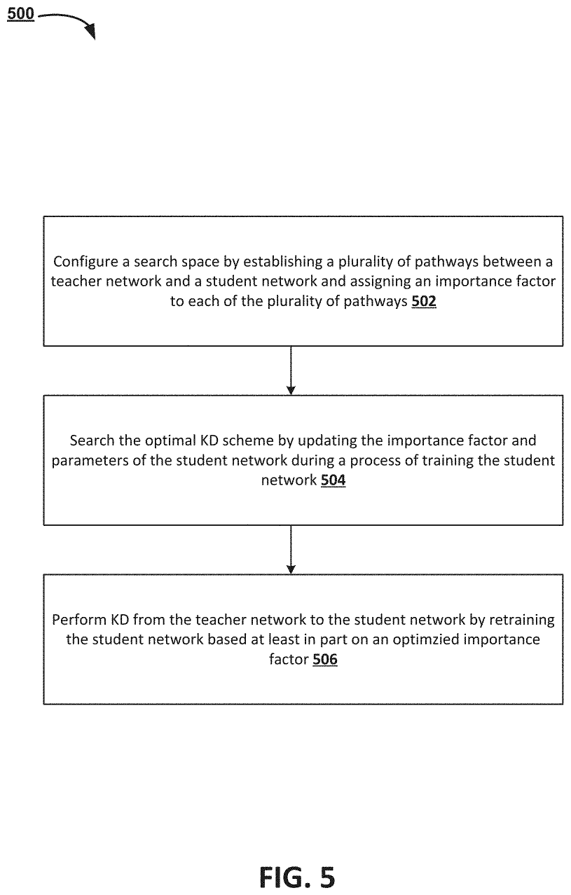

FIG. 5 depicts an example process 500 for identifying an optimal scheme of KD and performing KD based on the optimal scheme. Although depicted as a sequence of operations in FIG. 5, those of ordinary skill in the art will appreciate that various embodiments may add, remove, reorder, or modify the depicted operations.

At 502, a search space may be configured by establishing a plurality of pathways between a teacher network and a student network and assigning an importance factor to each of the plurality of pathways. The teacher network is pre-trained. The search space (e.g., the search space as shown in FIG. 2) may be configured for searching an optimal pathway of KD. The size of the search space may be different based on varying datasets for various vision tasks. A loss term may be computed to measure the difference between a teacher feature map and a student feature map along each of the plurality of pathways. An importance factor may be assigned to each of the plurality of pathways. The importance factor may be used to evaluate the importance of each pathway for knowledge distillation. The optimal KD scheme may be found by optimizing the importance factor.

In one embodiment, for a given pair of teacher and student networks, a set of transmitting feature maps of the teacher network and receiving feature maps of the student network may be sampled and defined. A plurality of pathways from transmitting layers to receiving layers may be established. In an example, a transform block may be added after each feature map of the student network. The transform block may convert a receiving feature map of the student network to match with a transmitting feature map of the teacher network for loss computation. The transform block may be any differentiable computation. In one example, a transform block may comprise several convolution layers and an interpolation layer to transform the spatial resolution of the feature map.

At 504, an optimal KD scheme may be searched by updating the importance factor and parameters of the student network during a process of training the student network. The optimal KD scheme may be searched during a process of training the student network. A dataset may be split into a training dataset and a validation dataset for the process of training the student network. The student network may be trained on the training dataset with a training loss encoding the supervision from both the teacher network and the ground truth labels associated with the training dataset. The validation dataset may be used to evaluate the performance of the student network. In the validation process, a validation loss may only measure a difference between the output of the student network and the ground truth labels associated with the validation dataset.

In one example, the importance factors and the parameters of the student neural network may be updated alternately during the process of training the student network. The training process is for searching an optimal scheme. The importance factor a obtained in each iteration may be stored for future use. The optimized importance factor may be found in the searching phase. A learned process for the importance factor may comprise much richer information than the final importance factor value. For example, it has been found that the weights at pathways from low-level feature maps of the teacher networks are relatively large at the beginning and small at the end; however, the weights at pathways from high-level feature maps of the teacher networks are relatively small at the beginning and large at the end. This information indicates that an optimal routine for KD could be that the student network learns simple knowledge at early stage and learns difficult knowledge at later stage.

At 506, knowledge distillation may be performed from the teacher network to the student network by retraining the student network based at least in part on the optimized importance factors. An optimal KD scheme may be identified by optimizing the importance factor. The optimized importance factor may be found during the process of training the student network. The optimized importance factor as well as all available data may be used to retrain the student network to perform KD. All the available data may comprise the training dataset and the validation dataset used during the process of training the student network. During the retraining process, only parameters of the student network are updated.

During the retraining process, there may be different ways to use the optimized importance factor obtained from the searching phase. In some embodiments, the importance factor obtained at the last iteration in the searching phase may be used for each iteration of the retraining phase. The student network may be retrained using the same importance factor obtained at the last iteration for each iteration of the retraining process. The evolution of the importance factor in the searching phase (i.e., the learnt process for important facotr) may encode much richer information than the final importance factor value. To make use of that information, in other embodiments, each iteration of the retraining process may use different importance factors. Since a number of iterations in the retraining process may be different from a number of iterations in the training process, linear interpolation may be used to compute the different importance factors for each iteration in the retraining process.

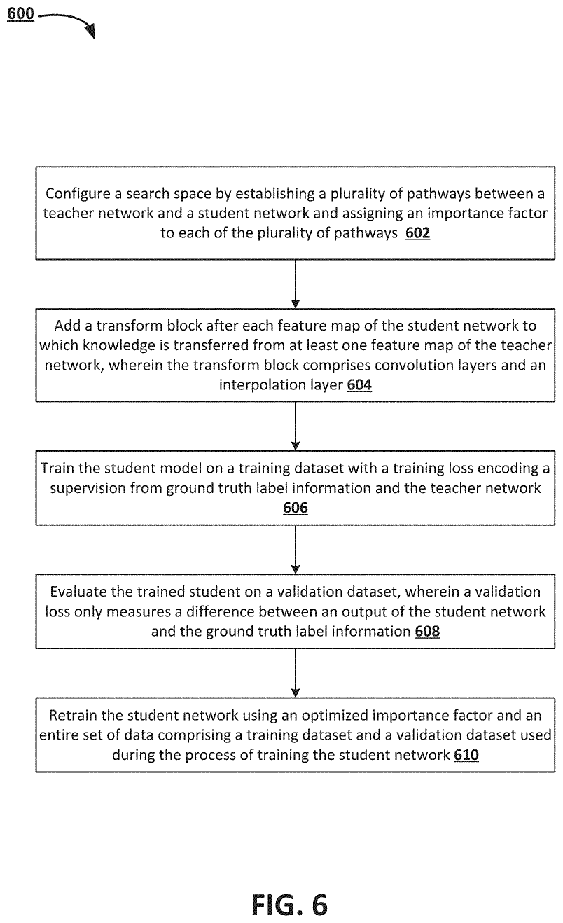

FIG. 6 depicts an example process 600 for identifying an optimal scheme of knowledge distillation for vision tasks. Although depicted as a sequence of operations in FIG. 6, those of ordinary skill in the art will appreciate that various embodiments may add, remove, reorder, or modify the depicted operations.

At 602, a search space may be configured by establishing a plurality of pathways between a teacher network and a student network and assigning an importance factor to each of the plurality of pathways. The teacher network is pre-trained. The search space (e.g., the search space as shown in FIG. 2) may be configured for searching an optimal pathway of KD. The size of the search space may be different based on varying datasets for various vision tasks. A loss term may be computed to measure the difference between a teacher feature map and a student feature map along each of the plurality of pathways.

In one embodiment, for a given pair of teacher and student networks, a set of transmitting feature maps of the teacher network and receiving feature maps of the student network may be sampled and defined. A plurality of pathways from transmitting layers to receiving layers may be established. An importance factor may be assigned to each of the plurality of pathways. The importance factor may be used to evaluate the importance of each pathway for knowledge distillation. The optimal KD scheme may be found by optimizing the importance factor.

At 604, a transform block may be added after each feature map of the student network. Knowledge may be transferred from at least one feature map of the teacher network to the student network. The transform block may comprise convolution layers and an interpolation layer. In one embodiment, knowledge may be transferred from any feature map of the teacher network (i.e., Fᵢ^{t}) to any feature map of the student network (i.e., Fⱼ^{s}) by penalizing the difference between these two feature maps. Since the feature maps may come from any stage of the neural network, they might be in different shapes and thus not directly comparable. Thus, additional computation may be required to bring these two feature maps into the same shape. To this end, a transform block may be added after each feature map of the student network. The transform block may convert a receiving feature map of the student network to match with a transmitting feature map of the teacher network for loss computation. The transform block could be any differentiable computation. A transform block may comprise several convolution layers and an interpolation layer to transform the spatial resolution of feature maps.

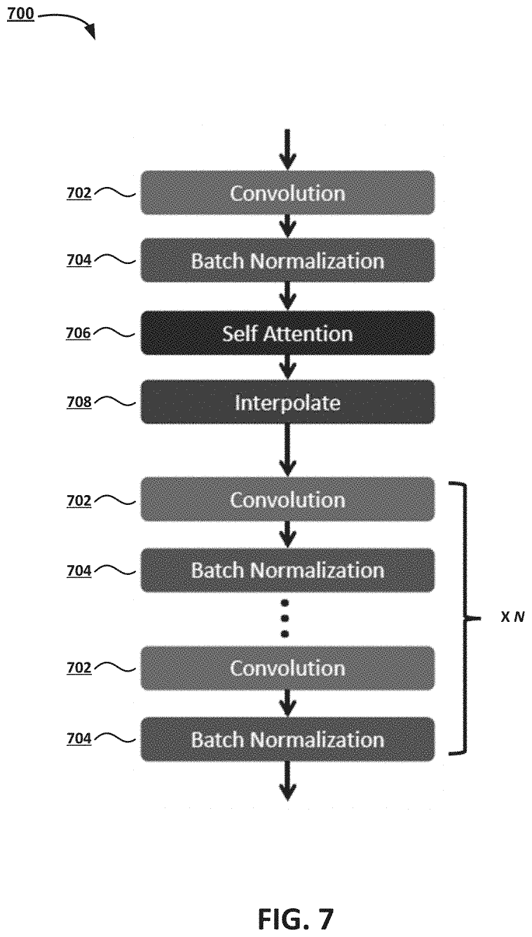

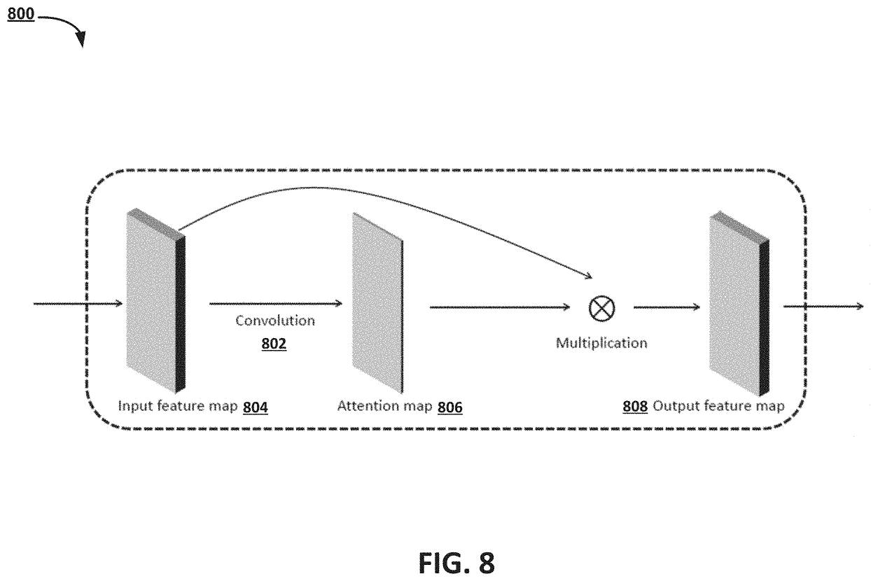

FIG. 7 illustrates an example architecture 700 of the transform block. The transform blocks may comprise a plurality of convolution layers 702, a plurality of batch normalization layers 704, a self-attention layer 706, and an interpolation layer 708 to transform the spatial resolution of the feature maps. The transform block may be configured to transform feature maps which are in different shapes into a same shape for comparison. The transform blocks may convert a receiving feature map of the student network to match with a transmitting feature map of the teacher network for loss computation. The transform blocks may be pre-defined. To implement the transformation, the transform block may be added after each feature map of the student neural network. FIG. 8 illustrates an architecture 800 of self-attention block, such as the self-attention block 706 shown in FIG. 7. In one embodiment, a convolution layer 802 may be applied to the input feature map 804 to generate a 1-channel attention map 806. Then the input feature map 804 may be multiplied with the attention map 806, and an output feature map 808 may be generated by the operation of multiplication.

Referring back to FIG. 6, a process of training a student network may be used to search an optimal KD scheme (e.g., the searching phase 302 as shown in FIG. 3). In the process of training the student network, the student network may be trained using a training dataset and validated using a validation dataset. At 606, the student model may be trained on a training dataset with a training loss encoding a supervision from ground truth label information and the teacher network. In one embodiment, a dataset may be split into a training dataset and a validation dataset for the process of training the student network. For example, the training dataset may comprise 80% of the entire dataset, and the validation dataset may comprise 20% of the entire dataset. The loss on the training dataset, for example, may be defined based on Equation 4. The student model may be trained on the training dataset with a training loss encoding the supervision from both the teacher network and the ground truth labels associated with the training dataset.

In one example, the importance factors and the parameters of the student neural network may be updated alternately during the process of training the student network. The importance of each knowledge transfer (i.e., each pathway) may be adjusted by regulating the importance factor. Due to the efficiency for KD scheme learning of the gradient-based method, importance factors may be updated by descending a gradient approximation, such as the approximation based on Equation 10.

The validation dataset may be used to evaluate the performance of the student network. At 608, the trained student may be evaluated on a validation dataset. A validation loss may only measure a difference between an output of the student network and the ground truth label information. The ground truth label information may be associated with the validation dataset. In one embodiment, the validation dataset may comprise 20% of the entire dataset. The loss on the validation dataset (i.e., validation loss), for example, may be defined based on Equation 5. An optimal importance factor minimizing the validation loss may be found in the searching phase. An optimal KD scheme may be identified to minimize the validation loss by applying a gradient-based mechanism. The optimal importance factors may be stored and used for the retraining phase.

The retraining phase may be configured to retrain the student network with the optimized importance factor. At 610, the student network may be retrained using the optimized importance factors and an entire set of data. The entire set of data may comprise a training dataset and a validation dataset used during the process of training the student network. In one embodiment, the optimized importance factor found in the searching phase may be used for KD in the retraining phase. Each pathway may be reweighted based on the optimal importance factor obtained from the searching phase. During retraining, only the parameters of the student network may be updated. The retraining phase may be utilized to retrain the student neural network with the optimal importance factor and all the available data. All the available data may comprise the training dataset and the validation dataset used during the process of training the student network (i.e., the searching phase). Knowledge distillation may be performed from the teacher network to the student network by retraining the student network with the optimal importance factor.

There may be different ways to use the optimal importance factors found in the searching phase. For example, the retraining phase may only use the optimized importance factors obtained at the last iteration in the searching phase for each iteration of the retraining phase. The student network may be retrained using the same importance factor obtained at the last iteration in the searching phase for each iteration of the retraining process. The evolution of the importance factor in the searching phase may encode much richer information than the final importance factor value. To make use of that information, in another example, each iteration of the retraining process may use different importance factors. Since a number of retaining iterations may be different from a number of training iterations, linear interpolation may be used to compute the different importance factors for each iteration in the retraining process.

To evaluate the performance of the framework described in the present disclosure, a plurality of benchmark tasks may be adopted. The plurality of benchmark tasks may include image classification, semantic segmentation, and depth estimation. For image classification, popularly used CIFAR-100 dataset may be used. For semantic segmentation, CityScapes dataset may be used. For depth estimation, NYUv2 dataset may be used. The proposed method may be compared mainly with knowledge review and corresponding baseline models on each task. All the methods may use the same training setting and hyper-parameters to implement a fair comparison. The training setting may comprise data pre-processing, learning rate schedule, number of training epochs, batch size and so on.

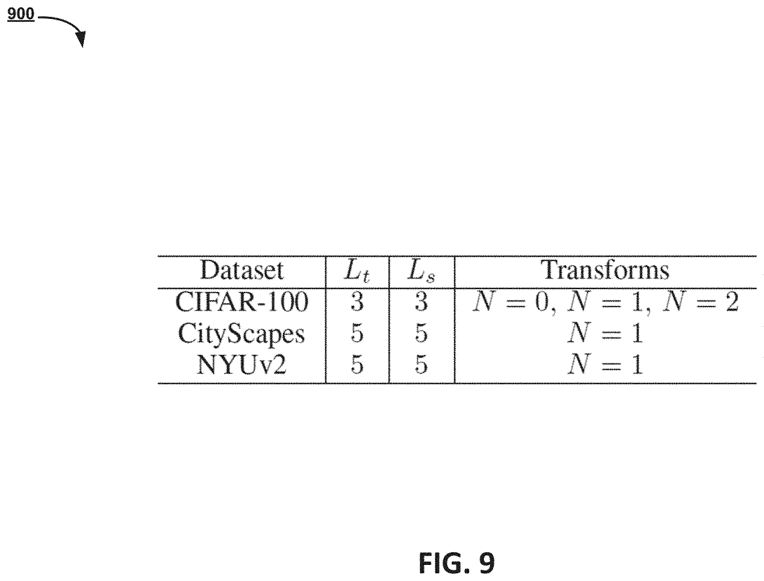

FIG. 9 illustrates example sizes of the search space on different datasets. In an example, on CIFAR-100 dataset, three feature maps of the teacher model and three feature maps of the student model may be selected. For each teacher/student pair, three transform blocks may be inserted, where N may be 0, 1, 2 respectively. For another example, on CityScapes dataset, five feature maps of the teacher model and five feature maps of the student model may be selected.

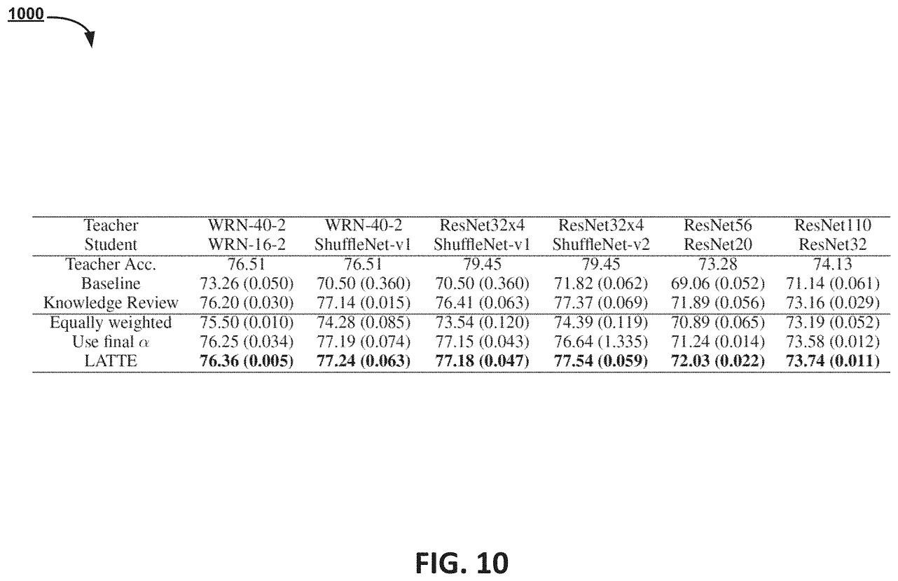

FIG. 10 illustrates varying performance ability of different schemes on CIFAR-100 dataset. The CIFAR-100 dataset contains 50000 training images and 10000 testing images. Each image in the CIFAR-100 dataset has a resolution of 32×32 pixels. Each image is labelled with one from 100 object classes. For training, image may be first padded by 4 pixels to each side. Then, a crop with resolution of 32×32 pixels may be randomly sampled from the padded image or its horizontal flip. Finally, the sampled crop may be normalized with the per-channel mean and standard values pre-computed over the whole dataset. For testing, the original image may be used.

Different network architectures are adopted for performance comparison. The network architectures may comprise ResNet, WideResNet, MobileNet, and ShuffleNet. The models may be trained for 240 epochs. The learning rate may be decayed by 0.1 for every 30 epochs after the first 150 epochs. Batch size is 128 for all the models. The initial learning rate is 0.02 for ShuffleNet and 0.1 for other models. The models may be trained with the same setting five times. The mean and variance of the accuracy on the testing set may be reported.

Using the CIFAR-100 dataset, the search may be run for 40 epochs. The learning rate for w (i.e., parameters of the student neural network) may be decayed by 0.1 at epoch 10, 20, and 30. The learning rate for α may be set to 0.05. Not all feature maps are used for knowledge distillation. Instead, only the ones after each down sampling stage may be used. To make the comparison fair and meaningful, Hierarchical Context Loss (HCL) may be used. For the retraining phase, linear interpolation may be used to expand the process of α from 40 epoch to 240 epochs to match its needed in KD.

Results are average values based on 5 runs. Variances are reported in the parentheses. The results prove that the LATTE scheme has significant improvements compared to other neural network architectures. In FIG. 10, the mean and variance of the accuracy on the testing dataset may be obtained and reported. “Equality weighted”, “Use final α”, and “LATTE” indicate the results using importance factor α. In the row “Equally weighted”, the searched α is not used in the retraining phase. Instead, each element of α is uniformly set to 1/L, where L is the length of α. As shown in the row “Equally weighted”, the results are worse than Knowledge Review (KR). That may indicate the selected pathways from KR are useful.

There may be two ways to use importance factor α. The first way is adopting the final learnt importance factor α values at the end of training. The results are shown in the row “Use final α”. In the row “Use final α”, the finally converged importance factor α is used at each iteration of the retrain phase. FIG. 10 shows that “Use final α” outperforms KR in many settings.

The second way is adopting the learnt process (i.e., the evolution of the importance factor in the searching phase). The results are shown in the row “LATTE”. FIG. 10 shows that “LATTE” outperforms KR significantly based on derived variations. This may be because at the searching phase, the student network weights w is evolving with a similar behavior as the retraining phase. Therefore, the LATTE KD scheme with the process has further improvements. FIG. 10 demonstrates that learning the importance factor is essential for generating an optimal KD scheme.

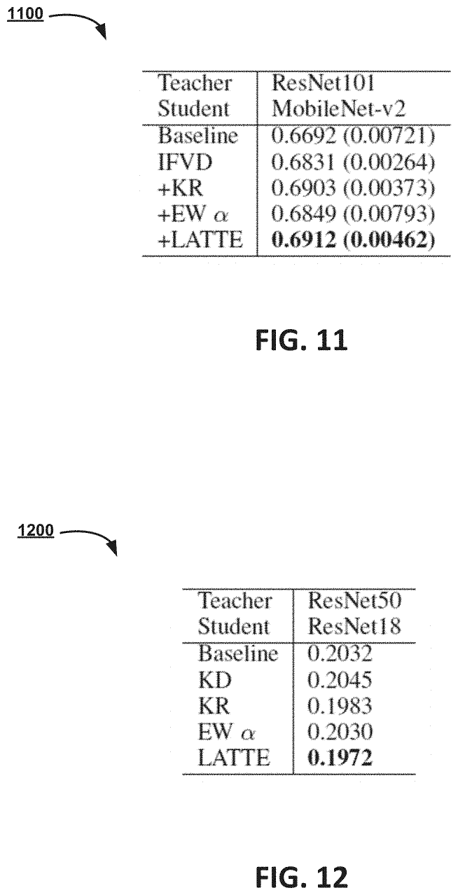

FIG. 11 illustrates varying performance ability of different schemes on CityScapes dataset. The CityScapes dataset is a semantic segmentation dataset. The performance using the framework in accordance with the present disclosure is compared with that of other knowledge distillation techniques. The training setting follows Intra-class Feature Variation Distillation (IFVD). IFVD is a response-based distillation method. IFVD may be combined with feature-based distillation method including KR and LATTE. “+KR” represents a combination of IFVD and KR. “+LATTE” represents a combination of IFVD and LATTE. “EW α” represents equally weighted a. The original IFVD did not run due to numerical issues, and the adversarial training loss in IFVD may be disabled. Results are shown as average values based on 5 runs. As shown in FIG. 11, the mean Intersection over Union (mIoU) on the validation set is reported. Standard deviation is reported in the parentheses. FIG. 11 illustrates that the searched scheme is better than the hand-crafted scheme. Moreover, the searched scheme suggests that the student neural network should learn from different teacher feature maps at different stages of the training process.

FIG. 12 illustrates varying performance ability of different schemes on NYUv2 dataset. Using NYUv2 dataset, estimation error on different schemes is reported. NYUv2 dataset is a widely used dataset for depth regression. Using NYUv2 dataset, “LATTE” is compared with the plain knowledge distillation (KD), knowledge review (KR), and equally weighted a (EW a). Root Mean Squared Errors (RMSE). As illustrated in FIG. 12, the LATTE framework in accordance with the present disclosure has better performance than other techniques for dense prediction tasks.

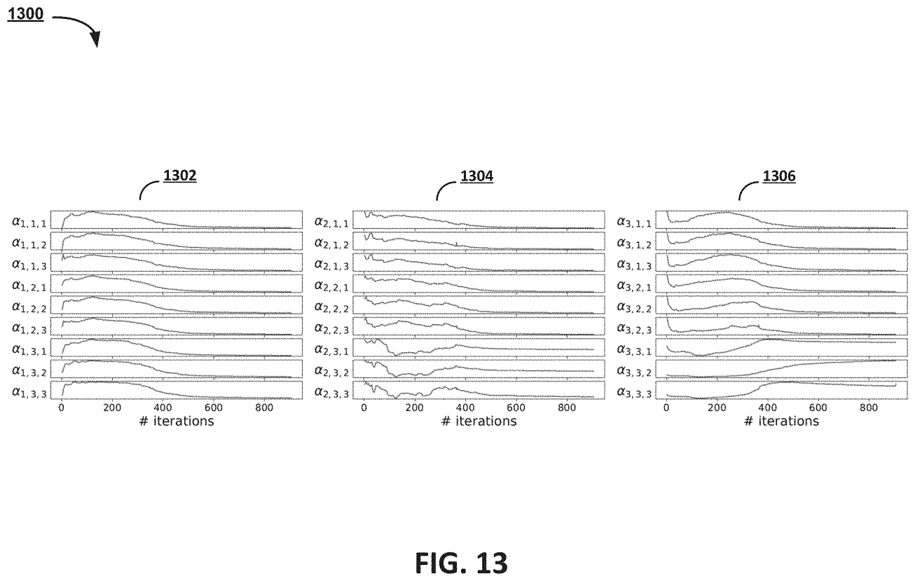

FIG. 13 illustrates example training curves of the teaching scheme parameter a. The training is implemented on CIFAR-100 dataset with WRN-40-2 as the teacher and WRN-16-2 as the student. x-axis indicates the number of iterations. The graph 1302 contains α[1, :, :], i.e., all the elements corresponding to the lowest-level feature map of the teacher. The graph 1304 corresponds to α[2, :, :], and the graph 1306 corresponds to α[3, :, :].

FIG. 13 shows that the importance factor a changes with time in searching phase of distilling WRN-40-2 (i.e., the teacher) to WRN-16-2 (i.e., the student). At the early stage of the training, the optimized teaching scheme focuses on transferring knowledge from low-level feature maps of the teacher neural network to the student neural network. When the training continues, the optimized teaching scheme gradually moves to the higher-level feature maps of the teacher neural network. High-level feature maps encode highly abstracted information of the input image. Compared to the low-level feature maps, high-level feature maps are more difficult to learn from. The learned process for the importance factor α is proved to be a function of time and encodes richer information than the final importance factor α value learnt in the searching phase.

The importance factor a generated in the searching phase may be used in different ways. For example, as shown in FIG. 10, equally weighted α, final α, and learnt process of α may be used. As illustrated in FIG. 10, the LATTE framework using learnt process of α (i.e., the evolution process of the importance factor in the searching phase) has the best performance.

The importance factor may be used to evaluate the importance of each pathway for knowledge distillation. For the purpose of numerical stability, normalization may be applied to the importance factor. FIG. 14 illustrates varying performance ability of different normalization methods. A plurality of normalization method may be evaluated. The normalized importance factor may be denoted as a. The unnormalized importance factor may be denoted as \tilde{α}. The normalized importance factors a may be viewed as a vector of length L. The evaluation may be conducted on CIFAR-100 dataset with WRN-28-4 as the teacher and WRN-16-4 as the student. As shown in FIG. 14, concat(\tilde{α}, 1) stands for concatenating \tilde{α} with a scalar 1. Results are the average values based on 5 runs. The first normalization method, i.e., softmax (concat(\tilde{α}, 1)), outperforms other methods. Therefore, the first normalization method may be used for normalization of α. Due to the appended scalar 1, the summation of α may be less than 1, while in softmax(\tilde{α}) the summation is exactly equal to 1.

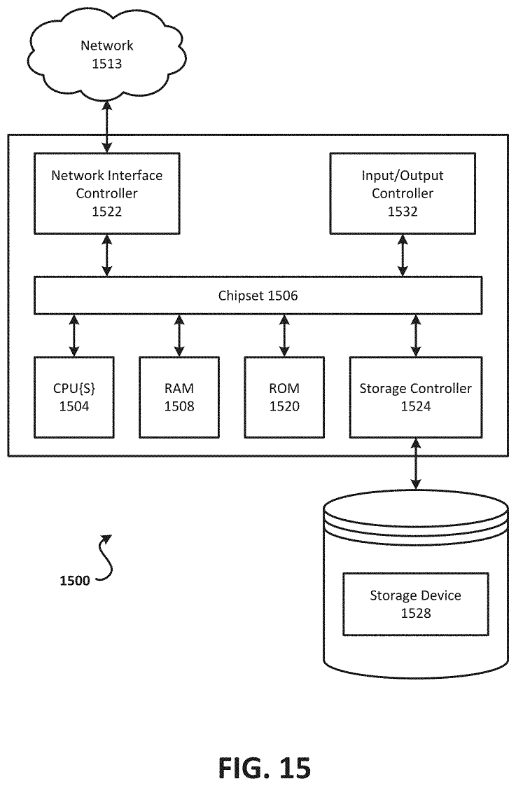

FIG. 15 depicts a computing device that may be used in various aspects. With regard to the example environment of FIG. 1, one or more of mission services 112, client device 104, or client device 124 may be implemented in an instance of a computing device 1500 of FIG. 15. The computer architecture shown in FIG. 15 shows a conventional server computer, workstation, desktop computer, laptop, tablet, network appliance, PDA, e-reader, digital cellular phone, or other computing node, and may be utilized to execute any aspects of the computers described herein, such as to implement the methods described in the present disclosure.

The computing device 1500 may include a baseboard, or “motherboard,” which is a printed circuit board to which a multitude of components or devices may be connected by way of a system bus or other electrical communication paths. One or more central processing units (CPUs) 1504 may operate in conjunction with a chipset 1506. The CPU(s) 1504 may be standard programmable processors that perform arithmetic and logical operations necessary for the operation of the computing device 1500.

The CPU(s) 1504 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 1504 may be augmented with or replaced by other processing units, such as GPU(s). The GPU(s) may comprise processing units specialized for but not necessarily limited to highly parallel computations, such as graphics and other visualization-related processing.

A user interface may be provided between the CPU(s) 1504 and the remainder of the components and devices on the baseboard. The interface may be used to access a random access memory (RAM) 1508 used as the main memory in the computing device 1500. The interface may be used to access a computer-readable storage medium, such as a read-only memory (ROM) 1520 or non-volatile RAM (NVRAM) (not shown), for storing basic routines that may help to start up the computing device 1500 and to transfer information between the various components and devices. ROM 1520 or NVRAM may also store other software components necessary for the operation of the computing device 1500 in accordance with the aspects described herein. The user interface may be provided by a one or more electrical components such as the chipset 1506.

The computing device 1500 may operate in a networked environment using logical connections to remote computing nodes and computer systems through local area network (LAN). The chipset 1506 may include functionality for providing network connectivity through a network interface controller (NIC) 1522, such as a gigabit Ethernet adapter. A NIC 1522 may be capable of connecting the computing device 1500 to other computing nodes over a network 1513. It should be appreciated that multiple NICs 1522 may be present in the computing device 1500, connecting the computing device to other types of networks and remote computer systems.

The computing device 1500 may be connected to a storage device 1528 that provides non-volatile storage for the computer. The storage device 1528 may store system programs, application programs, other program modules, and data, which have been described in greater detail herein. The storage device 1528 may be connected to the computing device 1500 through a storage controller 1524 connected to the chipset 1506. The storage device 1528 may consist of one or more physical storage units. A storage controller 1524 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 1500 may store data on a storage device 1528 by transforming the physical state of the physical storage units to reflect the information being stored. The specific transformation of a physical state may depend on various factors and on different implementations of this description. Examples of such factors may include, but are not limited to, the technology used to implement the physical storage units and whether the storage device 1528 is characterized as primary or secondary storage and the like.

For example, the computing device 1500 may store information to the storage device 1528 by issuing instructions through a storage controller 1524 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 1500 may read information from the storage device 1528 by detecting the physical states or characteristics of one or more particular locations within the physical storage units.

In addition or alternatively to the storage device 1528 described herein, the computing device 1500 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 1500.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A storage device, such as the storage device 1528 depicted in FIG. 15, may store an operating system utilized to control the operation of the computing device 1500. The operating system may comprise a version of the LINUX operating system. The operating system may comprise a version of the WINDOWS SERVER operating system from the MICROSOFT Corporation. According to additional aspects, the operating system may comprise a version of the UNIX operating system. Various mobile phone operating systems, such as IOS and ANDROID, may also be utilized. It should be appreciated that other operating systems may also be utilized. The storage device 1528 may store other system or application programs and data utilized by the computing device 1500.

The storage device 1528 or other computer-readable storage media may also be encoded with computer-executable instructions, which, when loaded into the computing device 400, transforms the computing device from a general-purpose computing system into a special-purpose computer capable of implementing the aspects described herein. These computer-executable instructions transform the computing device 1500 by specifying how the CPU(s) 1504 transition between states, as described herein. The computing device 1500 may have access to computer-readable storage media storing computer-executable instructions, which, when executed by the computing device 1500, may perform the methods described in the present disclosure.

A computing device, such as the computing device 1500 depicted in FIG. 15, may also include an input/output controller 1532 for receiving and processing input from a number of input devices, such as a keyboard, a mouse, a touchpad, a touch screen, an electronic stylus, or other type of input device. Similarly, an input/output controller 1532 may provide output to a display, such as a computer monitor, a flat-panel display, a digital projector, a printer, a plotter, or other type of output device. It will be appreciated that the computing device 1500 may not include all of the components shown in FIG. 15, may include other components that are not explicitly shown in FIG. 15, or may utilize an architecture completely different than that shown in FIG. 15.

As described herein, a computing device may be a physical computing device, such as the computing device 1500 of FIG. 15. A computing node may also include a virtual machine host process and one or more virtual machine instances. Computer-executable instructions may be executed by the physical hardware of a computing device indirectly through interpretation and/or execution of instructions stored and executed in the context of a virtual machine.

One skilled in the art will appreciate that the systems and methods disclosed herein may be implemented via a computing device that may comprise, but are not limited to, one or more processors, a system memory, and a system bus that couples various system components including the processor to the system memory. In the case of multiple processors, the system may utilize parallel computing.

For purposes of illustration, application programs and other executable program components such as the operating system are illustrated herein as discrete blocks, although it is recognized that such programs and components reside at various times in different storage components of the computing device, and are executed by the data processor(s) of the computer. An implementation of service software may be stored on or transmitted across some form of computer-readable media. Any of the disclosed methods may be performed by computer-readable instructions embodied on computer-readable media. Computer-readable media may be any available media that may be accessed by a computer. By way of example and not meant to be limiting, computer-readable media may comprise “computer storage media” and “communications media.” “Computer storage media” comprise volatile and non-volatile, removable and non-removable media implemented in any methods or technology for storage of information such as computer-readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information, and which may be accessed by a computer. Application programs and the like and/or storage media may be implemented, at least in part, at a remote system.

As used in the specification and the appended claims, the singular forms “a,” “an” and “the” include plural referents unless the context clearly dictates otherwise. Ranges may be expressed herein as from “about” one particular value, and/or to “about” another particular value. Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect.

It will be apparent to those skilled in the art that various modifications and variations may be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method of identifying an optimal scheme of knowledge distillation (KD) for vision tasks, comprising:
configuring a search space by establishing a plurality of pathways between a teacher network and a student network and assigning an importance factor to each of the plurality of pathways;
searching the optimal KD scheme by updating the importance factor and parameters of the student network during a process of training the student network; and
performing KD from the teacher network to the student network by retraining the student network based at least in part on an optimized importance factor.

2. The method of claim 1, wherein the configuring the search space further comprises:
adding a transform block after each feature map of the student network to which knowledge is transferred from at least one feature map of the teacher network, wherein the transform block comprises convolution layers and an interpolation layer.

3. The method of claim 1, wherein the searching the optimal KD scheme further comprises:
training the student model on a training dataset with a training loss encoding a supervision from ground truth label information and the teacher network; and
evaluating the trained student on a validation dataset, wherein a validation loss only measures a difference between an output of the student network and the ground truth label information.

4. The method of claim 3, further comprising:
identifying the optimal KD scheme by optimizing the importance factor, the optimized importance factor minimizing the validation loss.

5. The method of claim 4, further comprising:
approximating a gradient of the validation loss with respect to the importance factor based on:
$${∇}_{α} {L}_{v a l} ( {w}^{*} ( α ) ) \approx - ξ \frac{{∇}_{α} {L}_{train} ( {w}^{+} , α ) - {∇}_{α} {L}_{train} ( {w}^{-} , α )}{2 ϵ} ,$$
wherein α represents the importance factor, w*(α) represents the parameters of the student neural network trained with the importance factor α, Lᵥₐₗ represents the validation loss, ∇_{α}Lᵥₐₗ(w*(α)) represents the gradient of the validation loss with respect to the important factor α, ξ represents a learning rate of an inner optimization, Lₜᵣₐᵢₙ represents the training loss, ∈ represents a small positive scalar, w⁺ is defined as w+∈∇_{w}Lᵥₐₗ(w), w⁻ is defined as w−∈∇_{w}Lᵥₐₗ(w), and w is equal to w−ξ∇_{w}Lₜᵣₐᵢₙ(w, α).

6. The method of claim 1, wherein the retraining the student network based at least in part on the optimized importance factor further comprises:
retraining the student network using the optimized importance factor and an entire set of data comprising a training dataset and a validation dataset used during the process of training the student network.

7. The method of claim 6, further comprising:
retraining the student network using a same importance factor for each iteration of the retraining process, wherein the same importance factor is obtained at a last iteration during the process of training the student network.

8. The method of claim 6, further comprising:
retraining the student network using different importance factors for each iteration of the retraining process, the different importance factors computed using linear interpolation.

9. A system of identifying an optimal scheme of knowledge distillation (KD) for vision tasks, comprising:
at least one processor; and
at least one memory comprising computer-readable instructions that upon execution by the at least one processor cause the system to perform operations comprising:
configuring a search space by establishing a plurality of pathways between a teacher network and a student network and assigning an importance factor to each of the plurality of pathways;
searching the optimal KD scheme by updating the importance factor and parameters of the student network during a process of training the student network; and
performing KD from the teacher network to the student network by retraining the student network based at least in part on an optimized importance factor.

10. The system of claim 9, wherein the configuring the search space further comprises:
adding a transform block after each feature map of the student network to which knowledge is transferred from at least one feature map of the teacher network, wherein the transform block comprises convolution layers and an interpolation layer.

11. The system of claim 9, wherein the searching the optimal KD scheme further comprises:
training the student model on a training dataset with a training loss encoding a supervision from ground truth label information and the teacher network; and
evaluating the trained student on a validation dataset, wherein a validation loss only measures a difference between an output of the student network and the ground truth label information.

12. The system of claim 11, the operation further comprising:
identifying the optimal KD scheme by optimizing the importance factor, the optimized importance factor minimizing the validation loss.

13. The system of claim 9, wherein the retraining the student network based at least in part on an optimized importance factor further comprises:
retraining the student network using the optimized importance factor and an entire set of data comprising a training dataset and a validation dataset used during the process of training the student network.

14. The system of claim 13, the operations further comprising:
retraining the student network using a same importance factor for each iteration of the retraining process, wherein the same importance factor is obtained at a last iteration during the process of training the student network.

15. The system of claim 13, the operations further comprising:
retraining the student network using different importance factors for each iteration of the retraining process, the different importance factors computed using linear interpolation.

16. A non-transitory computer-readable storage medium, storing computer-readable instructions that upon execution by a processor cause the processor to implement operations comprising:
configuring a search space by establishing a plurality of pathways between a teacher network and a student network and assigning an importance factor to each of the plurality of pathways;
searching the optimal KD scheme by updating the importance factor and parameters of the student network during a process of training the student network; and
performing KD from the teacher network to the student network by retraining the student network based at least in part on an optimized importance factor.

17. The non-transitory computer-readable storage medium of claim 16, wherein the searching the optimal KD scheme further comprises:
training the student model on a training dataset with a training loss encoding a supervision from ground truth label information and the teacher network; and
evaluating the trained student on a validation dataset, wherein a validation loss only measures a difference between an output of the student network and the ground truth label information.

18. The non-transitory computer-readable storage medium of claim 17, the operation further comprising:
identifying the optimal KD scheme by optimizing the importance factor, the optimized importance factor minimizing the validation loss.

19. The non-transitory computer-readable storage medium of claim 16, wherein the retraining the student network based at least in part on an optimized importance factor further comprises:
retraining the student network using the optimized importance factor and an entire set of data comprising a training dataset and a validation dataset used during the process of training the student network.

20. The non-transitory computer-readable storage medium of claim 19, the operations further comprising:
retraining the student network using a same importance factor for each iteration of the retraining process, wherein the same importance factor is obtained at a last iteration during the process of training the student network; or
retraining the student network using different importance factors for each iteration of the retraining process, the different importance factors computed using linear interpolation.
